(19) United States
(12) Patent Application Publication
(10) Pub. No.: US 2009/0327230 A1
(43) Pub. Date: Dec. 31, 2009

(54) STRUCTURED AND UNSTRUCTURED DATA MODELS

(75) Inventors: Lewis Charles Levin, Seattle, WA (US); Brian Meek, Redmond, WA (US); Patrice Y. Simard, Bellevue, WA (US)

Correspondence Address: Himanshu S. Amin;Amin, Turocy & Calvin, LLP, National City Center - 24 th Floor, 1900 E. 9th Street, Cleveland, OH, 44114, US

(73) Assignee: MICROSOFT CORPORATION, Redmond, WA (US)

(21) Appl. No.: 12/147,574

(22) Filed: Jun. 27, 2008

(51) Int. Cl. G06F 17/30

(52) U.S. Cl. 707/3; 707/102; 707/101; 707/E17.006; 707/E17.014

(57) ABSTRACT

Structured and/or unstructured data is processed with the aid of a data model. The data model provides a conceptual description of source content that can be generated or otherwise modified automatically as a function of data, models, and/or structure associated with the data. Both structured and unstructured data can be viewed in terms of high-level content rather than a lower level physical model. Among other things, this view can be employed to aid search as well as data sharing.

### BACKGROUND

The ubiquity of computers and like devices has resulted in digital data proliferation. Technology advancements and cost reductions over time have enabled computers to become commonplace in business and at home. Individuals interact with a plurality of computing devices daily including work computers, home computers, laptops and mobile devices such as phones, personal digital assistants, media players, and/or hybrids thereof. Consequently, an enormous quantity of digital data is generated each day including messages, documents, pictures, music, video, etc. Generated data is stored and accumulated over time for later retrieval, analysis, mining, or other use. Generally, data falls into one of two categories: structured or unstructured.

Structured data is data structured or organized in a specific manner to facilitate identification and retrieval of data, for instance in response to a query. Computer databases are the most common example of structured data since they house data as structured collections of records. In particular, a schema provides a structural description of the types of data and relationships amongst data held in a database. Further, schemas are organized or modeled as a function of a particular database model. The most popular database model today is the relational database model. This model specifies that information be organized in terms of one or more tables including a number of rows and columns where relationships are represented utilizing values common to more than one table. In this case, the schema can act to identify specific table, row, and column names.

Unstructured data is the opposite of structured data. More specifically, it does not include any defined or standard structure to aid processing. There are two primary classes of unstructured data, namely bitmap and textual. Bitmap data is non-language based spatially arranged bits. Examples of bitmap data include images, audio, and video. Textual data is language based and includes email, word processing documents, web pages, and reports, among others.

It is to be noted that data conventionally classified as unstructured may not be completely devoid of structure. For example, a word processing document will include a plurality of words that together satisfy a grammar of the written language. As another example, a web page can include a high degree of structure directed toward formatting. However, there is no structure to facilitate more complex contextual computer processing. Sometimes people refer to this class of data as semi-structured to clarify that the data does in fact include some structure.

The overwhelming majority of data is currently stored in an unstructured or semi-structured manner. Indeed, it is has been estimated that eight-five percent of business data is unstructured. Accordingly, while data is plentiful, knowledge is not easily attainable from the data.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to data processing and more particularly processing of structured, unstructured, and/or semi-structured data. According to an aspect of the disclosed subject matter, a data model is automatically generated that provides a conceptual description of data content at one or more hierarchical levels. As a result, a high-level structural view is provided upon data including varying amounts of structure.

The generated data model or content data model can subsequently be applied to improve processing in several situations. In accordance, with an aspect of the disclosure, the data model can be utilized in conjunction with searching of structured and/or unstructured data. In this case, query results can be organized in accordance with the data model to facilitate location of relevant information by navigating a hierarchical structure, for example. According to yet another aspect of the disclosure, the model can be employed in conjunction with data transformation from a first form to at least a second form, thereby aiding data sharing.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of model generation system in accordance with a disclosed aspect.

FIG. 2 is a block diagram of a representative model generation component according to an aspect of the disclosure.

FIG. 3 is a block diagram of a system for generating extractor components in accordance with a disclosed aspect.

FIG. 4 is a block diagram of a search system in accordance with an aspect of the disclosed subject matter.

FIG. 5 is a block diagram of a search system including a generation component in accordance with an aspect of the disclosure.

FIG. 6 is a block diagram of a data processing system according to an aspect of the disclosed subject matter.

FIG. 7 is a flow chart diagram of a data processing method according to an aspect of the disclosure.

FIG. 8 is a flow chart diagram of a query processing method in accordance with a disclosed aspect.

FIG. 9 is a flow chart diagram of a transformation method according to an aspect of the disclosure.

FIG. 10 is a flow chart diagram of a data processing method utilizing content extraction in accordance with a disclosed aspect.

FIG. 11 is a schematic block diagram illustrating a suitable operating environment for aspects of the subject disclosure.

FIG. 12 is a schematic block diagram of a sample-computing environment.

### DETAILED DESCRIPTION

Systems and methods relating to data modeling and processing are described in detail hereinafter. A model is generated to capture high-level content associated with structured, unstructured data, and/or semi-structured data. The model provides a structured and conceptual view of data including varying amounts of structure. Data processing tasks can be enabled or improved with aid from such a model. In one instance, a search can be performed over one or both of structured and unstructured data and results can be returned in a content navigable form. For example, hierarchical structure can be selected or pivoted upon to facilitate location of relevant data. In another case, data can be transformed into different formats (e.g., unstructured to structured, legacy to new . . . ).

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

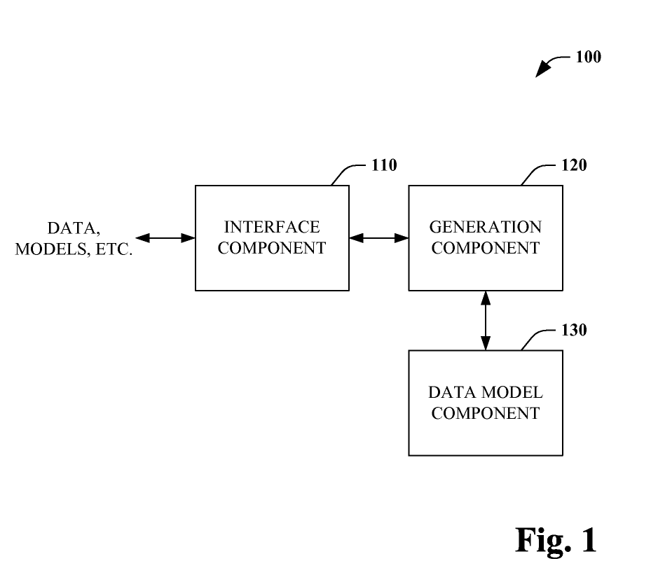

Referring initially to FIG. 1, a model generation system 100 is depicted in accordance with an aspect of the claimed subject matter. The system 100 includes an interface component 110 that receives, retrieves or otherwise obtains or acquires information useful for model generation. For example, the interface component 110 can acquire data (e.g., structured, unstructured, semi-structured . . . ) and/or other models, schemas, taxonomies or the like. Generation component 120 interacts with information supplied by the interface component 110 and automatically generates or produces at least one data model component 130. The model component 130 describes the structure of particular data at a high level. In other words, the model component 130 expresses data content. Accordingly, the model component 130 can also be referred to herein as a content model or content model component 130.

In general, the model component 130 and/or associated schema can include entities, classes of entities, entity attributes, and relationships amongst entities and attributes, among other things. In one embodiment, the model 130 enables content to be represented hierarchically including various levels of granularity. More specifically, the model 130 can include aggregated, generalized, and/or summarized facts based on facts that are more specific. For example, consider an unstructured text document that includes the words “buckeyes,” “tigers” and “bowl,” among others. At a higher level of granularity, the model can include the term “sports” or even more specifically “college football” describing the document content, thereby distinguishing it from documents about trees, large cats, and bowling balls. As another example, where a document includes an itemized list of expenses, the model component 130 can include aggregate computations including total and/or average expenses.

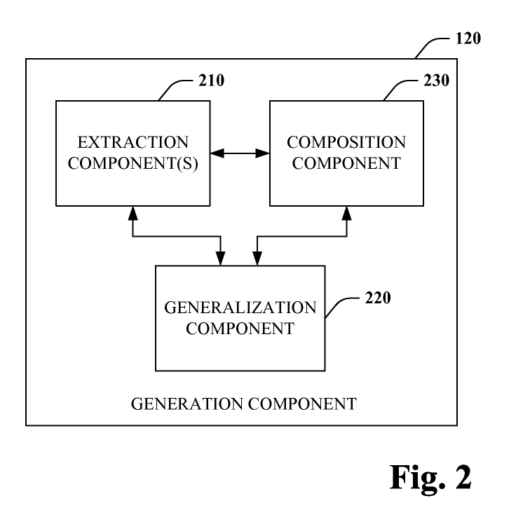

Turning attention to FIG. 2, a representative generation component 120 is illustrated in accordance with an aspect of the claimed subject matter. The generation component 120 is a mechanism that can generate, update, and/or refine the data model 130, automatically. This can be accomplished during a separate analysis period or dynamically at runtime. Further, the generation component 120 can also generate, update, and/or refine a model as a function of any available information. One type of information that is available is data itself.

The generation component 120 includes one or more extraction components 210 to analyze the data. More specifically, the extraction component 210 or set of extraction components 210 provides a mechanism for extracting or otherwise identifying particular data or structure of data. For example, extraction components 210 can be built or trained to identify names and addresses within data. This can be accomplished utilizing known data (e.g., names, addresses . . . ), characteristics of data (e.g., first name followed by last, numbers preceding street . . . ), and/or metadata, among other things. It is to be appreciated, however, that extracting a single specific structure like address provides only a small amount of structural information. The more structure that can be extracted the more accurate and informative the model. Moreover, the extraction component 210 can interact with generalization component 220 to further aid model building.

The generalization component 220 facilitates model generation by analyzing all extracted data and classifying the data appropriately. In other words, the component 220 can inject generalizations as a function for provided information. In one embodiment, a hierarchy can be built based on extracted data. In this case, the leaf nodes of the hierarchy can represent the extracted data and the generalizations can be the parent nodes describing subclasses where suitable. In this manner, the generalization component 220 infuses valuable content information a various levels of granularity.

The generation component 120 also includes a composition component 230 communicatively coupled to the extraction component 210 and generalization component 220. Another source of information pertaining to data structure can be other models, schemas, taxonomies, among others, associated with specific or like data. The composition component 230 can compose a content model has a function of other structural information. For example, where a schema is provided for processing a document for a specific purpose, this schema can be employed to aid generation of a content model as described herein. Where multiple models, schema or the like are available, they can be reconciled and utilized to identify structure. In one instance, one or more weighting and tie breaking techniques can be employed for composed data models that return conflicting results. Furthermore, it is to be noted that data models themselves can be considered as data and the same or similar processing can be applied to them as applies to data (e.g., conflict resolution). The generalization component 220 can also be applied to a model generated by the compositional component 230 to further conceptualize data structures. Further, the compositional component 230 can work alone or in combination with the extraction component(s) 210 to generate a high-level conceptual view of data content.

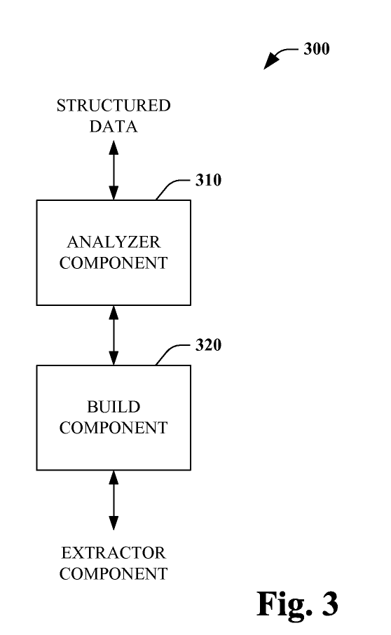

FIG. 3 illustrates an extractor component generation system 300 according to an aspect of the claimed subject matter. While schema extractors can be manually produced, they can also be automatically generated as a function of the structured data at run time, for instance. As shown, the system 300 includes an analyzer component 310 that analyzes relevant structured data such as a data schema, for example. From this analysis, various structural elements, tags or the like can be identified as well as associated data. Build component 320 can utilize information acquired by analysis component 210 to build or construct an extractor component. Subsequently, the extractor itself or related structures can be generalized and applied to unstructured data.

By way of example and not limitation, suppose a product schema is acquired for digital versatile disks (DVD) players. Upon analysis it can be determined that some high definition players are Ethernet enable while others are not. An extractor component can therefore be built that determines whether a high definition player is Ethernet enabled. Further yet, based on the analysis it can be learned, inferred or otherwise determined that HD DVD players are Ethernet enabled while Blu-ray players are not. As a result, whenever a HD DVD player is identified, “Ethernet enabled” can be associated with the player. As will be described further infra, this can form the basis for a pivot point upon which data can be navigated.

Once a comprehensive content model is constructed, it can be employed in many useful ways. In particular, data is of little use unless it is easily locatable. Accordingly, search is one significant application. Currently, a large amount of data is not easily searchable because it is because of a lack of appropriate structure. Consider, for instance, information that is practically locked away in textual documents, emails and the like. Conventionally, a simple word search can be performed. What results, however, is a lengthy list of irrelevant matches that obscure desirable results. With the aid of a content model, structure or a structured view can be added to improve location of relevant search results.

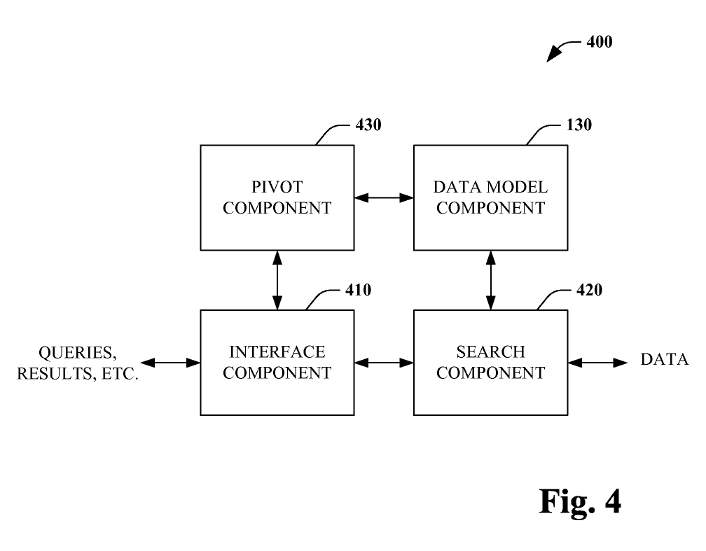

Turning attention to FIG. 4, a search system 400 is illustrated in accordance with an aspect of the claimed subject matter. The system includes an interface component 410 for receiving queries and returning results. For example, the interface component 410 can be embodied as a graphical user interface (GUI) of varying style and/or format. Upon receipt of a query from the interface component 410, the search component 420 can execute the query against a data source and return results. Unlike conventional search engines, however, search component 420 can utilize structural information regarding data provided by the data model component 130. In one embodiment, the data model component 130 can represent structured data that can be searched. Alternatively, the data model component 130 can provide a structured view of data over which a search can be performed. In either instance, it should be appreciated that data can be modeled or structured dynamically at runtime and/or at crawl time.

Pivot component 430 can be employed to organize query results for presentation as a function of the data model component 130. For instance, results can be presented in one or more hierarchies in which a user can interact. In other words, a user can navigate query results by interacting or pivoting within one or more hierarchies. This pivoting can also initiate new searches to populate a hierarchical category, among other things.

As an added benefit of structuring, previously structured data and unstructured data can be queried concurrently with similar effectiveness. (Of course, a pivot point can be employed amongst results to enable navigation of either structured or unstructured data separately.) Conventionally, locating relevant information is easier with structured data as opposed to unstructured or semi-structured data. Utilization of a data model 130 as described herein improves search over unstructured and semi-structured data. Furthermore, it is to be appreciated that the data model component 130 can also be employed to further aid searching of structured data.

What follows is a brief example to clarify disclosed aspects further. It is to be appreciated that the exemplary scenario and discussion are provided solely to aid clarity and understanding with respect to aspects of the claimed subject matter. The example is not intended to limit the scope of the appended claims in any manner. Application of aspects to structured data is considered first followed by unstructured data.

One challenge of searching structured data is that there are too many results for a user to assimilate. For example, if a search for “ABC Company” is performed on a structured database or databases of an enterprise resource management system, any transaction including “ABC Company,” “ABC,” or “Company” will result which could potentially be thousands of transactions. However, if a data model is utilized that provides hierarchies in significant subject domains like customer, results can be narrowed to the most relevant transactions. Instead of presenting every record that contains the words “ABC” and/or “Company,” results can be filtered utilizing a model that has descriptive terms in various subject domains. The model can also represent quantitative values like a sales amount and can return a summary such as all sales transactions with ABC Company in a dollar amount or all invoices to ABC Company or visits to ABC Company.

The model can include descriptors and/or data attributes that are potentially interesting in particular subject matter domains. This can be leveraged to return a summary and/or aggregate results utilizing the model to understand what data attributes are interesting, what rules can be used to aggregate those attributes, and what the relevant terms are in a variety of different subject domains. Accordingly, rather than seeing a thousand records that pertain to “ABC Company,” results can be returned pertaining to sales transactions, invoices or the like. Additionally, these classes or categories can be expanded where further detail is desired.

With respect to structured data, the data model can act as a mediating taxonomy to facilitate searching of such data. This is especially significant where there is too much data, users do not understand the underlying data, and they do not have any a priori notion of how to organize the data. In this case, the model provides those benefits, among others.

The model can provide similar benefits with respect to unstructured data as those provided for structured data. Continuing with the above example, there could be millions of text documents inside a data center that include the words “ABC Company” in various contexts. When specifying a query, it can be difficult to identify terms that will return interesting results. However, utilizing a data model as described supra, search results can be returned with are organized and navigable in a conceptual manner.

While search can build a general index of almost every non-noise term, relevancy ranking is a challenge. On the World Wide Web (“web”), there is a variety of interesting algorithms for relevancy ranking based on cross-site linking, among other things. However, there is a question as to how relevancy should be computed when private content is searched. The data model provides a way to organize all hits to increase the likelihood that a searcher will be able to locate pertinent information easily. For instance, if it was know that “ABC Company” was an entry in a customer domain or a hierarchy of customers by geography or industry, then one is able to filter out documents that include a customer “ABC” from the concept of learning the “ABC's.”

As per building such a data model, it can be done automatically in numerous ways. For instance, where there is a taxonomy built for another purpose such as data analysis, this taxonomy can be employed if it is relevant to query results. Further, multiple models, schemas or taxonomies can be piggybacked to help find relevant non-noise terms and/or provide a hierarchical or otherwise structured navigation of results. Additionally or alternatively, structure or contextual information can be extracted automatically and surface as navigable pivots. For example, some generic pivots pertaining to geographic location, type of document, author(s), and the like can be computed on the fly as documents are retrieved. Accordingly, there is little difference if data is structured, semi-structured, or unstructured. Some structure or pivot points can be embedded as metadata, while in other instances the same structure may need to be extracted dynamically. One benefit is that a whole data source or sources can be searched without the implication that everything is structured and/or pre-labeled, which is not the case.

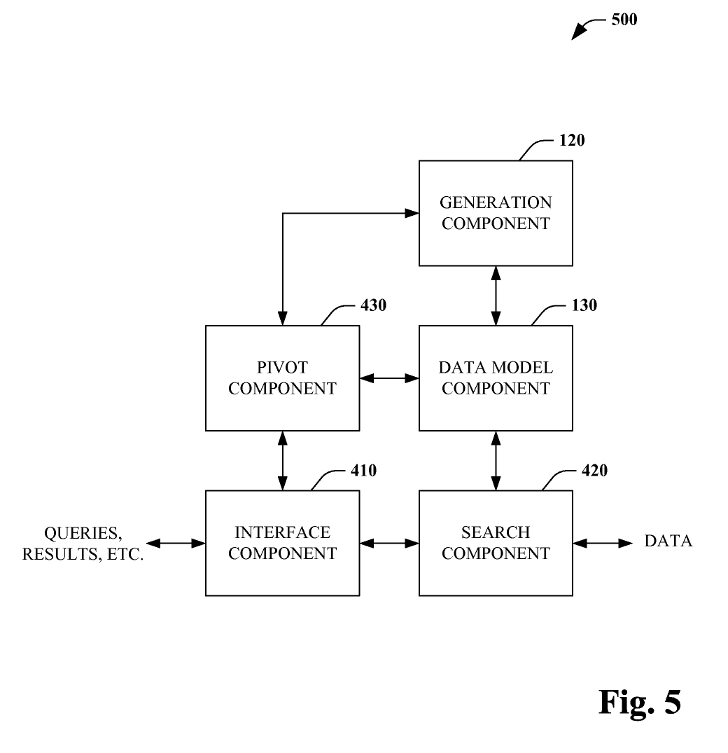

Referring to FIG. 5, another search engine system 500 is illustrated in accordance with an aspect of the claimed subject matter. Similar to system 400 of FIG. 4, system 500 includes the interface component 410, search component 420, data model component 130, and pivot component 430, as previously described. Moreover and as discussed above, the model can be generated, updated, or refined utilizing any available information utilizing generation component 120. In a search environment, there is data particular to the provided functionality that can be employed by the generation component 120 to update the data model component 130. In one instance, user queries can be leveraged. Queries provide inherent information regarding structure or context associated with data especially when queries are repeated. Based thereon, the generation component 120 can infer or otherwise identify structure and/or context and add such information to the data model component 130. For example, where there are repeated queries including the terms “ABC” and “Customer,” the model can be modified to reflect that “ABC” can be a “Customer.” Similarly, information about how users navigate hierarchical results can be indicative of structure, lack thereof, or misclassification, among other things, which can be employed to alter the data model component 130. For instance, if it is observed that many users navigate a first hierarchy only to later navigate a second hierarchy to locate a document of interest, the model component 130 may be modified to alter the manner in which data is classified.

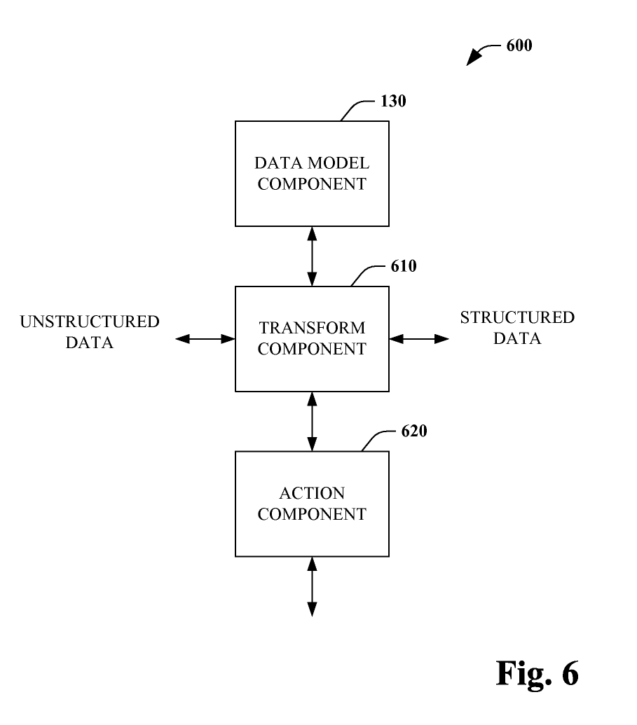

In addition to search, the data model component 130 finds applicability in data processing and more specifically data transformation. Turning to FIG. 6, a data processing system 600 is illustrated in accordance with an aspect of the claimed subject matter. The system 600 includes the data model component 130, as previously described, and a transform component 610. The data model component 130 can provide a mechanism for identifying and defining data content in an organized manner to facilitate interaction with such data. This information alone or in conjunction with links to the original physical schema facilitates transforming data from a first form to a second form. Action component 620 can control how data is transformed as a function of an action to be performed. For example, where document context is sought, unstructured or semi-structured data can be transformed to structured data. In another example, data from one application can be transformed or translated to data for another application. Among other things, this can enable sharing of data between legacy applications and newer applications and/or alteration of data formats between legacy and new. Such transformation or conversion can be automatic in one embodiment. However, the claimed subject matter is not limited thereto.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. By way of example and not limitation, the pivot component 430 can be separate as shown or incorporated within the interface component 410. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the generation component 120 can utilize such mechanisms to generate data model components 130 for instance by inferring and/or extracting significant structure, content and/or context.

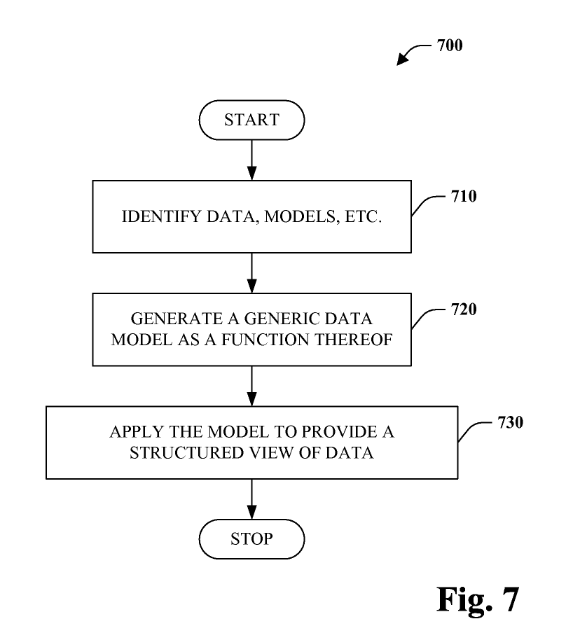

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a data processing method 700 is depicted in accordance with an aspect of the claimed subject matter. At reference numeral 710, data, models, schemas, taxonomies, and the like are identified. At numeral 720, a generic data model is generated from the identified information. The data model captures content, structure, and/or context associated with data at a higher level than any associated physical schema. At reference 730, the model is applied to provide a structured view of data. In one instance, this can provide a way to add structure to unstructured or semi-structured data. However, this does not exclude application to structured data. The model can also be applied to structured data to add additional or different structured thereto to facilitate subsequent processing.

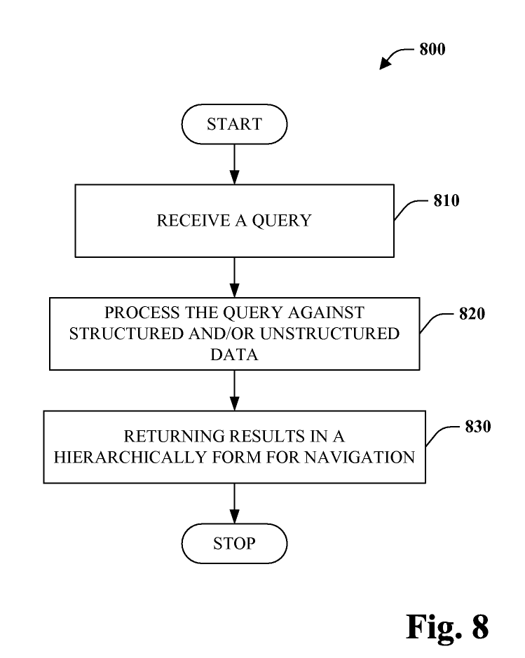

FIG. 8 depicts a query processing method 800 according to an aspect of the claimed subject matter. At reference numeral 810, a query is received. The query is processed against data including but not limited to at least one of structured, unstructured, and/or semi-structured data at 820. Note that query processing itself can be performed with or without aid from a generated content model. At numeral 830, query results are returned in a hierarchically navigable form in accordance with a content model. Users can subsequently pivot amongst conceptual and/or contextual terms to locate relevant information. In one embodiment of this method, the content model utilized to present the results in an organized form can be generated automatically and dynamically upon resultant data as a function of pre-existing and/or inferred structure, among other things.

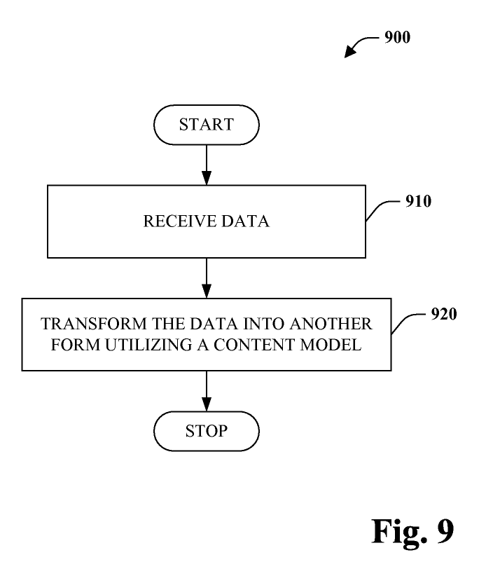

Turning attention to FIG. 9, a flow chart diagram is provided illustrating a transformation method 900 according to an aspect of the claimed subject matter. At reference numeral 910, data is received, retrieved, or otherwise acquired. This data is subsequently transformed, at numeral 920, from a first form to a second form utilizing a content data model as described herein. For example, unstructured data can be transformed to structured data or legacy format data can be converted to new format data. Furthermore, while more conceptual in nature than a physical schema, the model can provide a programmatic way to lead to real physical schemas.

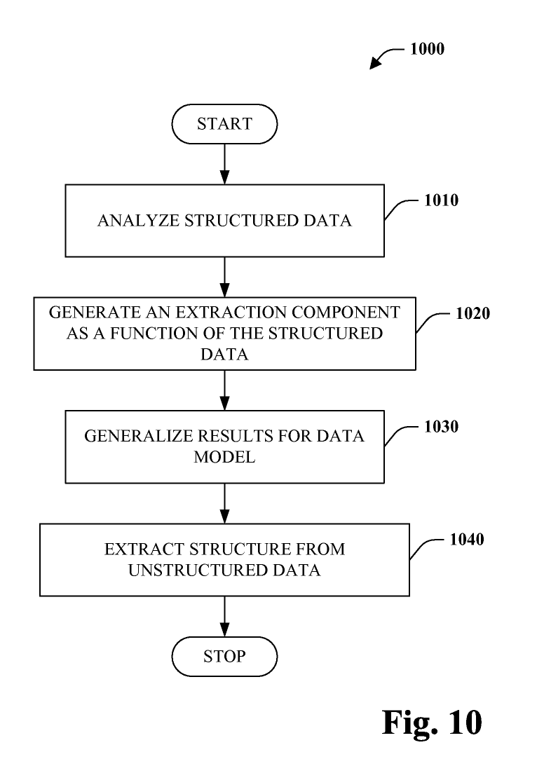

FIG. 10 depicts a method of data processing 1000 according to an aspect of the claimed subject matter. At reference numeral 1010, relevant structured data is identified and analyzed in an attempt to locate useful structure. At numeral 1020, an extraction component or content extractor is generated as a function of the structured data and more specifically the structure of interest. The resultant structure is generalized where necessary at 1030. At reference numeral 1040, the structure is extracted from unstructured data utilizing generated extractors. The result can be a model including hierarchical levels for describing unstructured data content.

As used herein the word “unstructured” is meant to cover “semi-structured” data as well unless otherwise noted. While the term semi-structured is meant to denote that data does in fact include some structure, it is not the same structure as that associated with structured data and conversely unstructured data. For example, semi-structure can refer to the grammatical structure of words in a particular language or tags for formatting, among other things. Accordingly, semi-structured data is essentially unstructured in terms of the relevant structured discussed herein.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the all or portions of the claimed aspects. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

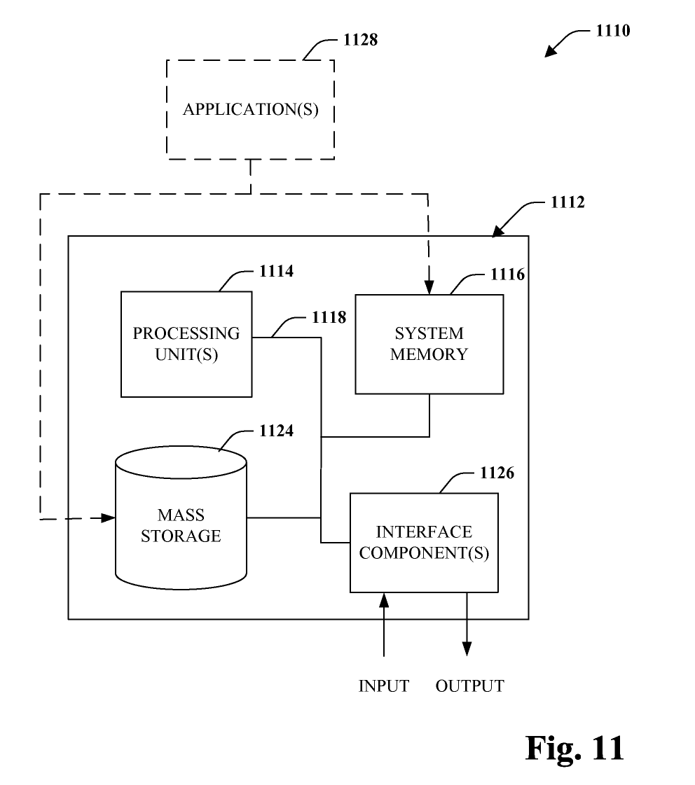

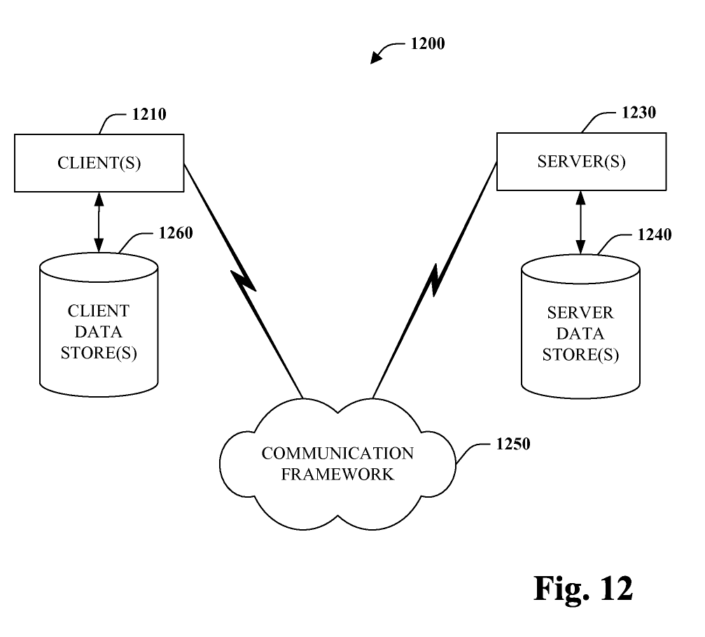

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory, or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g., CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

Client/server interactions can be utilized with respect with respect to various aspects of the claimed subject matter. By way of example and not limitation, data resident on client(s) 1210 and/or server(s) 1230 can be transformed into structured data or alternatively a structured view provided over such data. Furthermore, content model generation as well as application can occur on a client 1210, a server 1230 or distributed across one or more clients 1210 and servers 1230. For instance, a query can be submitted to a server 1230 network service, which in turn processes the query and identifies results. A model can be generated automatically at runtime via the same or different server 1230, while application of the model to the query results to produce a navigable hierarchy of content can be provided by yet another server 1230 service and or the querying client 1210.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A system that facilitates generic content data model construction and data navigation, comprising:
an interface component that acquires data from a source; and
a generation component that automatically generates from the data a generic content data model that classifies content at multiple conceptual levels to afford a structured view of at least one of structured or unstructured data to facilitate navigation of the data, wherein the structured data includes semantic structure, absent from the unstructured data, that defines meaning and relations amongst data entities.

2. The system of claim 1, further comprising an extraction component that extracts structure from the data to aid model generation.

3. The system of claim 2, further comprising a component that generalizes the extracted structure.

4. The system of claim 2, further comprising a component that analyzes structured data and a component that constructs an extraction component as a function thereof.

5. The system of claim 4, the extraction component is constructed dynamically at runtime.

6. The system of claim 1, further comprising a component that composes the data model from other data models, schemas, and/or taxonomies.

7. The system of claim 1, further comprising a component to search across structured and unstructured data.

8. The system of claim 7, the generation component updates the model as a function of repeated query actions.

9. The system of claim 7, further comprising a component that returns query results in one or more hierarchical structures.

10. A query processing method, comprising:
processing an acquired query over unstructured data;
obtaining a content data model related to the unstructured data that defines conceptual classifications of data at various levels of granularity; and
returning query results in an organized manner in accordance with the data model, wherein the model provides a mediating taxonomy that facilitates location of pertinent information.

11. The method of claim 10, further comprising processing the query over structured data.

12. The method of claim 10, further comprising enabling pivotable navigation of the results.

13. The method of claim 12, further comprising extracting pivot points automatically as a function of known information.

14. The method of claim 10, further comprising inferring structure as a function of structured data.

15. The method of claim 10, further comprising altering the data model as a function of repeated queries wherein the queries provide structural information.

16. The method of claim 10, further comprising aggregating quantitative data.

17. The method of claim 10, further comprising generating the content data model at runtime or crawl time.

18. A system for processing and/or interacting with unstructured data, comprising:
means for converting unstructured data to structured data automatically utilizing a content data model that classifies data conceptually at various levels; and
means for performing an action on the structured data.

19. The system of claim 18, comprising a means for changing data formats.

20. The system of claim 17, comprising a means for sharing data between applications.
